(19) United States
(12) Patent Application Publication
(10) Pub. No.: US 2008/0159496 A1
(43) Pub. Date: Jul. 3, 2008

(54) Method and System for Detecting a Transfer of an End Point Device

(75) Inventor: Daniel Peter Brown, Palatine, IL (US)

Correspondence Address: Motorola, Inc.;Law Department, 1303 East Algonquin Road, 3rd Floor, Schaumburg, IL, 60196, US

(73) Assignee: GENERAL INSTRUMENT CORPORATION, Horsham, PA (US)

(21) Appl. No.: 11/616,346

(22) Filed: Dec. 27, 2006

(51) Int. Cl. H04M 11/00

(52) U.S. Cl. 379/93.03

(57) ABSTRACT

A method and system for detecting a transfer of an endpoint device are disclosed. For example, the method receives an indication of a transfer of an endpoint device to a new user by a service provider. The method then notifies a subscriber associated with the endpoint device that the indication of the transfer was received by the service provider.

### FIELD OF THE INVENTION

The present invention relates generally to telecommunication subscription services and, in particular, the ability to transfer rights of the subscription services to another user.

### BACKGROUND OF THE INVENTION

Currently, users may use portable telecommunication devices, such as cell phones, for example via a subscription to services provided by a cellular service provider. Generally, these portable telecommunication devices will not function without the subscription services. Moreover, requiring personal identification to use the portable telecommunication devices may become more prevalent in the future as portable telecommunication devices are capable of storing and transmitting more and more data, some of which may be private or confidential. Furthermore, it is likely that services will be valued according to bandwidth consumption and/or media convergence, as may be managed by IP Multimedia Service (IMS) networks. Thus, a typical subscription will include a mix of commodity services such as, for example, low-bandwidth voice and higher value services such as, for example, streaming video, multi-media and the like.

Access to the services provided by the cellular service provider may be obtained by authentication. For example, authentication may be performed by inputting a username and password. In another example, authentication may be performed by inserting a removable module associated with a specific subscriber such as, for example, a SIM card on GSM compatible cell phones. In particular, both users and service providers are likely to insist upon user authentication, in addition to device and/or subscription authentication, to control access to at least the high-valued services, as described above.

However, due to the authentication requirements, trying to lend a portable telecommunications device to another person such as, for example, another family member or friend may prove to be difficult. For example, the family member or friend may be unable to remember a complicated username and password. Therefore, a need exists for a method and system for transferring rights of subscription services.

### SUMMARY OF THE INVENTION

In one embodiment, the present invention discloses a method and system for detecting a transfer of an endpoint device. For example, the method receives an indication of a transfer of an endpoint device to a new user by a service provider. The method then notifies a subscriber associated with the endpoint device that the indication of the transfer was received by the service provider.

### BRIEF DESCRIPTION OF THE DRAWINGS

The teaching of the present invention can be readily understood by considering the following detailed description in conjunction with the accompanying drawings, in which:

FIG. 1 illustrates an exemplary architectural overview of the present invention;

FIG. 2 illustrates an exemplary flow chart of a method for transferring rights of one or more subscription services;

FIG. 3 illustrates a more detailed exemplary flow chart of a method for transferring rights of subscription services; and

FIG. 4 illustrates a high level block diagram of an exemplary general purpose computer suitable for use in performing the functions described herein.

### DETAILED DESCRIPTION

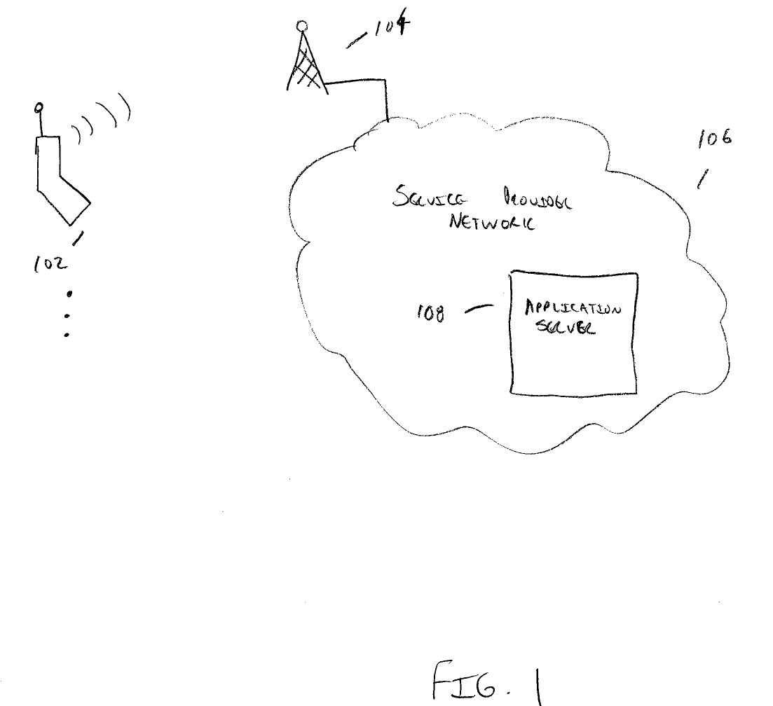

An exemplary architectural overview of a network 100 is illustrated in FIG. 1. In an exemplary embodiment, network 100 includes an endpoint device 102, a cellular network tower 104 and a service provider network 106. Although only one endpoint device 102 is illustrated, the embodiments of the present invention are not limited to a single endpoint device. Similarly, although only a single cellular network tower 104 is illustrated, one skilled in the art will recognize that a service provider network 106 may comprise numerous cellular network towers.

Endpoint device 102 may be any portable telecommunications device such as, for example, a cellular telephone (cell phone), a messaging device, e.g., a Blackberry™ device of Research In Motion Limited of Waterloo, Ontario, a push-to-talk phone or a personal digital assistant (PDA) with telecommunications capability. Moreover, endpoint device 102 may be equipped with biometric sensing device or equipment such as, for example, a thumb print reader for capturing a thumb print, a retinal scanner for capturing an image of a retina, a camera for capturing a facial image, a microphone for capturing a voice signal, or any combination thereof. In one illustrative embodiment, the biometric sensing equipment such as, for example, the thumb print reader may be deployed in a natural ergonomic position on the endpoint device 102. In other words, the subscriber or user may simply hold the phone in a natural way as if the subscriber were using the endpoint device and the thumb print reader is strategically deployed on the endpoint device such that it will automatically scan the subscriber's thumb print without interrupting the subscriber. Consequently by having the biometric sensing equipment strategically placed on endpoint device 102, if the endpoint device 102 is passed around to other people such that the other people may simply examine the subscriber's endpoint device 102, unnecessary biometric readings will not occur.

In one embodiment, service provider network 106 employs an application server 108. Application server 108 may store information inputted by both the subscriber via, for example endpoint device 102, as well as a service provider of the network 106. Moreover, application server 108 may store biometric data and pre-defined profiles created by the subscribers, as will be discussed in further detail below. Finally, application server 108 may also contain all the application software necessary to execute notifications to the subscriber, as also will be discussed in further detail below.

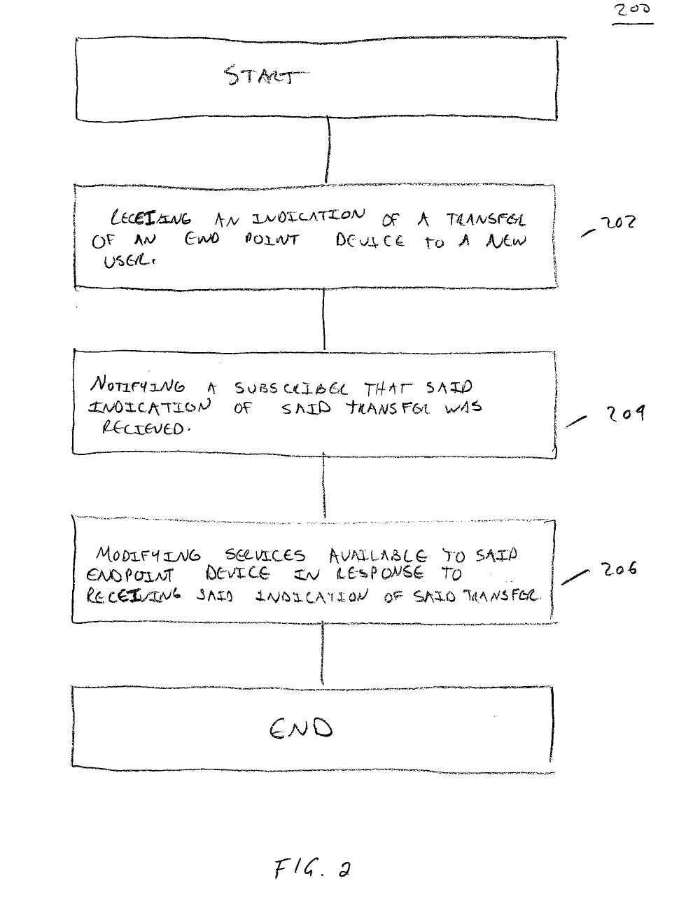

FIG. 2 illustrates an illustrative flow chart of a method 200 for transferring rights of one or more subscription services. The method 200 begins at step 202 where an indication of a transfer of an endpoint device 102 to a new user is received. The indication may be as simple as the subscriber calling a toll free number to inform a service provider that the subscriber is about to transfer his or her endpoint device 102 to a new user.

In a more advanced embodiment, the indication may be automatically detected by biometric sensing equipment on the endpoint device 102. For example, a thumb print reader may detect a thumb print that is different from the subscriber's thumb print, a retinal scan may detect a different retinal identification, a camera may detect a different facial identification or a microphone may detect a different voice identification. In addition, a pre-defined time interval may be used in conjunction with the biometric sensing equipment. For example, the indication may not be received immediately upon sensing a different biometric reading. The indication may be received after the pre-defined interval elapses subsequent to sensing the different biometric reading.

In one embodiment, application server 108 may contain the subscriber's biometric information that is entered when the subscriber first subscribes to a new service. The stored biometric information can then be used in the future for authenticating the subscriber. Using the example of a thumb print, when the subscriber uses the phone, the thumb print is automatically scanned and transmitted back to the application server 108 via the service provider network 106. When the subscriber wishes to transfer the endpoint device 102 to a new user, the endpoint device may automatically read the new user's thumb print via the thumb print reader. The new user's thumb print is transmitted to the application server 108. In one embodiment, if the application server 108 detects that the new user's thumb print does not match the subscriber's thumb print, then the application server 108 will deem that an indication of a transfer of the endpoint device 102 has been received.

In another exemplary embodiment, if the endpoint device 102 determines that the new user's thumbprint does not match the subscriber's thumbprint, then the endpoint device 102 may immediately limit the services available locally on the endpoint device 102 to the new user. Services available locally on the endpoint device 102 may be, for example, an address book, a contact list, a program, a digital file and the like. Simultaneously, the endpoint device 102 may transmit to the application server 108 the new user's thumbprint after the new user has held the endpoint device 102.

In one embodiment, a time proximity measure of the transfer in the biometric model may also be used. For example, application server 108 may require that the new user's thumb print is received within a short time duration or period, e.g., within a few seconds of the subscriber's last thumb print reading. This may ensure that the transfer was inherently approved by the subscriber. If the new user's thumb print is not received within a few seconds of the subscriber's last thumb print, then application server 108 may assume that the endpoint device 102 was stolen. Moreover, in one illustrative embodiment, application server 108 may require that the subscriber's thumb print be received after the new user's thumb print after a certain predefined amount of time, for example a few hours, to ensure that the endpoint device 102 is returned. If the subscriber's thumb print is not received again by application server 108 within the predefined time period, application server 108 may assume that the endpoint device 102 was stolen.

At step 204, the subscriber is notified that the indication of the transfer was received. The notification may be in any form of communication, for example, an email, a telephone call to an alternate number that the subscriber may be reached at, an instant message or any combination thereof. The notification allows the subscriber to be alerted that a transfer of his or her endpoint device 102 has been detected by the service provider. Consequently, if the subscriber did not approve the transfer, the subscriber may take the necessary action immediately to modify the subscriber's services to endpoint device 102. Such modifications may be, for example, limiting services, turning off all services, and the like.

Moreover, the notification advantageously serves to alert the subscriber immediately that the endpoint device 102 may have been lost. As such, excessive amounts of time, e.g., many hours, days or weeks, will not pass before the subscriber realizes that his or her endpoint device 102 is lost. If the subscriber realizes the endpoint device 102 is lost or stolen, upon notification, then the subscriber may request that services to the endpoint device 102 be modified such as, for example, limiting services, turning off all services, and the like.

Furthermore, the service provider will be provided with a time record that will indicate as to approximately when the transfer may have occurred, thereby allowing the service provider to ascertain what charges should be associated with the subscriber before transfer of the endpoint device versus charges that were incurred after the transfer of the endpoint device. This additional information will allow the service provider to provide flexible billing options to the subscriber and also to mitigate illegal charges if the endpoint device was reported to be stolen.

In one illustrative embodiment, the default setting is set to continue providing services (e.g., a complete range of service or a modified set of services as discussed below) to the endpoint device 102, even if no response is received from the subscriber after notifying the subscriber. In other words, endpoint device 102 may continue to function until the service provider of network 106 is informed otherwise by the subscriber.

At step 206, services available to said endpoint device 102 may optionally be modified such as, for example, limiting services, turning off all services, and the like, in response to the indication of the transfer. More specifically, a predefined set of services in accordance with a user profile can be provided if a transfer is detected by the service provider. For example, when the subscriber signs up for services with the service provider of network 106, the subscriber may select a pre-defined set of services. This pre-defined set of services can be stored into a user profile by application server 108.

For example, the subscriber may wish to limit one or more services (e.g., barring access to 1-900 numbers) that are available to endpoint device 102 when the endpoint device is transferred to a minor. Moreover, the subscriber may wish to activate one or more services, e.g., a follow-me service such as a Global Positioning System (GPS) tracking service, for the endpoint device 102, such that the minor's location may be known at all times to the subscriber. In another example, the subscriber may wish to maintain all services available to endpoint device 102 when the endpoint device is transferred to the subscriber's spouse. Finally, the subscriber may provide a default set of services in the event that application server 108 is unable to identify the new user. For example, the default minimum profile of services may be to only allow emergency numbers to be called if the endpoint device is transferred to an unknown new user.

In an exemplary embodiment, if the subscriber dials a toll free number to indicate to the service provider that a transfer of the endpoint device 102 to a new user is about to occur, the service provider may allow the subscriber to input various information associated with the transfer to application server 108. For example, the new user can be identified by the application server 108 based upon the subscriber's input. In turn, application server 108 may obtain the pre-defined set of services associated with the identified new user and then provides only the pre-defined set of services associated with the new user to the endpoint device 102.

In another exemplary embodiment, if the transfer of endpoint device 102 is detected via the biometric sensing equipment, then the application server 108 may identify the new user based upon the biometric reading received from the endpoint device 102. The new user may be identified by comparing the current biometric reading to biometric information that has been previously stored at application server 108. As discussed above, the biometric information may be provided initially by the subscriber when the subscriber signed up for services with the service provider of network 106.

Once the new user is identified, the application server 108 identifies the pre-defined set of services associated with the new user. Subsequently, only the pre-defined set of services associated with the new user is provided to the endpoint device 102.

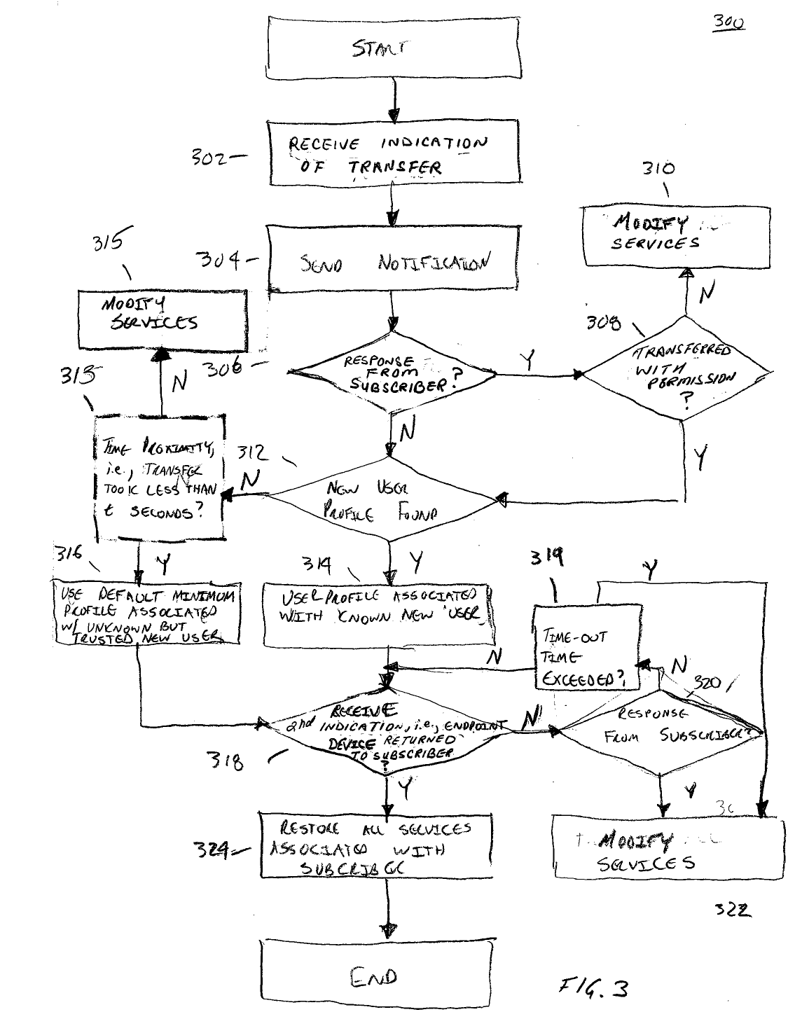

FIG. 3 illustrates a more detailed exemplary flow chart of a method 300 for transferring rights of subscription services in accordance with the present invention. Method 300 begins at step 302 where an indication of a transfer of the endpoint device 102 is received, e.g., as discussed above in step 202 of FIG. 2.

At step 304, similar to step 204 of FIG. 2, a notification of the transfer is sent to the subscriber. Subsequently at step 306, method 300 may wait to see if a response is received from the subscriber or user. If a response is received, method 300 proceeds to step 308 where method 300 may determine if the endpoint device 102 was transferred with the permission of the subscriber. If the endpoint device 102 was transferred without the permission of the subscriber, then the subscriber may request all services to endpoint device 102 be modified at step 310 such as, for example, limiting services, turning off all services, and the like. If the response indicates that the endpoint device 102 was transferred with the permission of the subscriber, then method 300 may proceed to step 312. It should be noted that if no response is received from the subscriber at step 306, the method 300 may proceed to step 312.

At step 312, method 300 may determine if a user profile with a pre-defined set of one or more services associated with the new user is found. If a user profile with a pre-defined set of services associated with the new user is found, then the method 300 may proceed to step 314 where the located user profile with a pre-defined set of services associated with the known new user is used for endpoint device 102. However, if a user profile with a pre-defined set of services associated with the new user is not found, then the method 300 may proceed to step 316 where a default minimum profile, as discussed above, associated with an unknown, but trusted new user may be used for the endpoint device 102.

Alternatively in an exemplary embodiment, if time proximity in the biometric model is being used, method 300 may proceed to optional step 313. At optional step 313, method 300 may determine if the transfer of the endpoint device 102 took less than t seconds, where t may be a pre-defined time interval that is acceptable such as, for example, 15 seconds, 30 seconds or any acceptable time interval. If method 300 determines that the transfer did not take less than t seconds, then method 300 may proceed to step 315 where the subscriber may request all services to endpoint device 102 be modified at step 310 such as, for example, limiting services, turning off all services, and the like. If method 300 determines that the transfer occurred in less than t seconds, then method 300 may proceed to step 316.

At step 318, method 300 may wait for a second indication that the endpoint device 102 has been transferred back to the subscriber. For example, the second indication may be the subscriber calling the toll free number a second time to provide a second indication to application server 108 that the endpoint device 102 was transferred back to the subscriber. In another exemplary embodiment, the second indication may be, as discussed above in the biometric model, when the subscriber's thumb print reading is received by application server 108 within a specific time period after receiving the new user's thumb print reading.

If a second indication is not received at step 318, method 300 proceeds to step 320. At step 320, method 300 may determine whether a response is received from the subscriber. For example, it is possible that it will take some time before a subscriber will realize that the endpoint device is missing under a theft scenario. Under this scenario, the pre-defined set of services would have been activated for the endpoint device 102. However, the subscriber may still subsequently contact the service provider to request that all services to endpoint device 102 be modified, for example, limiting services, turning off all services, and the like. If such a response is received from the subscriber at step 320, then method 300 may proceed to step 322 to modify services to endpoint device 102. If such a response is not received from the subscriber at step 320, then method 300 may proceed to step 319, where a time-out timer may be used to determine whether the endpoint device 102 has exceeded a pre-determined time of absence from the subscriber without further advice from the subscriber. If this pre-determined time has not been exceeded, then method 300 may loop back to step 318. However, if this pre-determined time is exceeded, then method 300 may proceed to step 322 where services may be modified, for example, limiting services, turning off all services, and the like.

If a second indication is received at step 318, then the method 300 proceeds to step 324 where all services associated with the subscriber prior to the transfer are restored to endpoint device 102. Subsequently, method 300 ends.

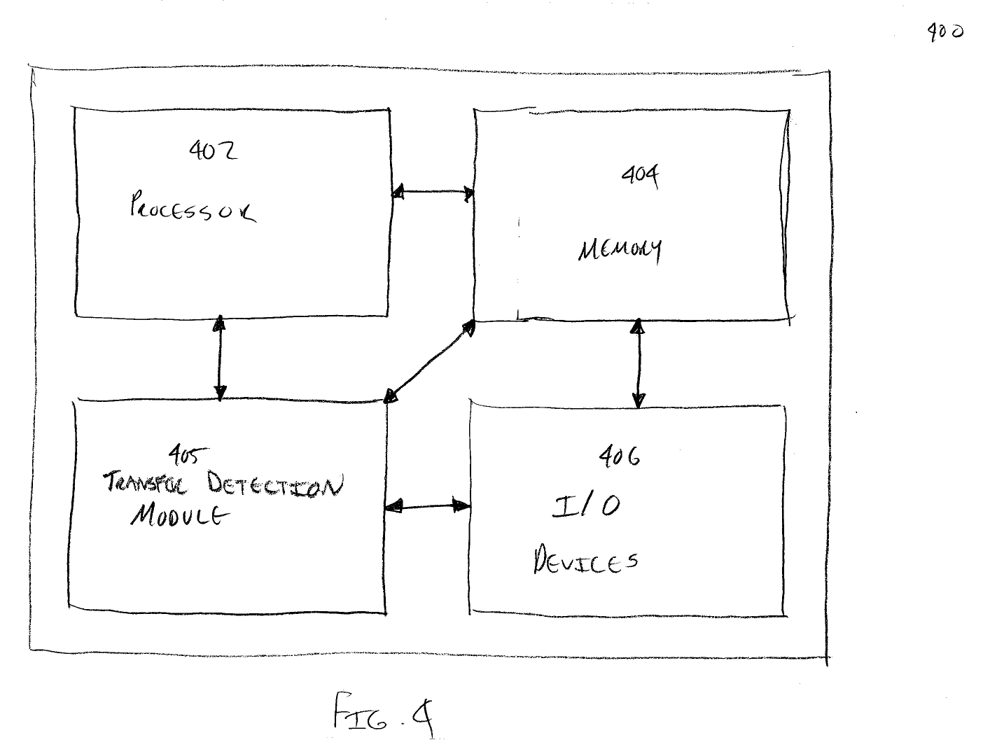

FIG. 4 illustrates a high level block diagram of an exemplary general purpose computer suitable for use in performing the functions described herein. As depicted in FIG. 4, the general purpose computer 400 comprises a processor element 402 (e.g., a CPU), a memory 404, e.g., random access memory (RAM) and/or read only memory (ROM), a transfer detection module 405 for detecting a transfer of an endpoint device, and various input/output devices 406 (e.g., storage devices, including but not limited to, a tape drive, a floppy drive, a hard disk drive or a compact disk drive, a receiver, a transmitter, a speaker, a display, a speech synthesizer, an output port, and a user input device (such as a keyboard, a keypad, a mouse, and the like)).

It should be noted that the present invention can be implemented in software and/or in a combination of software and hardware, e.g., using application specific integrated circuits (ASIC), a general purpose computer or any other hardware equivalents. In one embodiment, the processes provided by the transfer detection module 405 for detecting a transfer of an endpoint device can be loaded into memory 404 and executed by processor 402 to implement the functions as discussed above. As such, the processes provided by the transfer detection module 405 for detecting a transfer of an endpoint device (including associated data structures) of the present invention can be stored on a computer readable medium or carrier, e.g., RAM memory, magnetic or optical drive or diskette and the like.

While the foregoing is directed to illustrative embodiments of the present invention, other and further embodiments of the invention may be devised without departing from the basic scope thereof, and the scope thereof is determined by the claims that follow.

What is claimed is:

1. A method for detecting a transfer of an endpoint device, comprising:
receiving an indication of a transfer of an endpoint device to a new user by a service provider; and
notifying a subscriber associated with said endpoint device that said indication of said transfer was received by said service provider.

2. The method of claim 1, further comprising:
modifying one or more services available to said endpoint device in response to said indication of said transfer.

3. The method of claim 1, wherein said receiving step comprises receiving a call from said subscriber.

4. The method of claim 1, wherein said receiving step comprises receiving a plurality of biometric readings.

5. The method of claim 4, wherein each of said plurality of biometric readings comprises at least one of: a thumb print, an image of a retina, an image of a face, or a voice signal.

6. The method of claim 4, wherein said plurality of biometric readings comprises a first biometric reading associated with said new user and a second biometric reading associated with said subscriber.

7. The method of claim 6, wherein said first biometric reading associated with said new user and said second biometric reading associated with said subscriber are received within a predefined time duration.

8. The method of claim 1, wherein said notifying comprises at least one of: calling said subscriber, emailing said subscriber, or instant messaging said subscriber.

9. The method of claim 2, wherein said modifying step comprises:
identifying said new user;
identifying a pre-defined set of services associated with said new user; and
providing only said pre-defined set of services to said new user.

10. The method of claim 2, further comprising:
receiving a second indication that said endpoint device is transferred back to said subscriber; and
restoring all services associated with said subscriber.

11. The method of claim 1, further comprising:
receiving a response from said subscriber requesting that services available to said endpoint device be modified; and
modifying services available to said endpoint device.

12. A computer-readable medium having stored thereon a plurality of instructions, said plurality of instructions including instructions which, when executed by a processor, cause said processor to perform said steps of a method for detecting a transfer of an endpoint device, comprising:
receiving an indication of a transfer of an endpoint device to a new user by a service provider; and
notifying a subscriber associated with said endpoint device that said indication of said transfer was received by said service provider.

13. The computer-readable medium of claim 12, further comprising:
modifying one or more services available to said endpoint device in response to said indication of said transfer.

14. The computer-readable medium of claim 12, wherein said receiving step comprises receiving a call from said subscriber or receiving a plurality of biometric readings.

15. The computer-readable medium of claim 14, wherein each of said plurality of biometric readings comprises at least one of: a thumb print, an image of a retina, an image of a face, or a voice signal.

16. The computer-readable medium of claim 14, wherein said plurality of biometric readings comprises a first biometric reading associated with said new user and a second biometric reading associated with said subscriber.

17. The computer-readable medium of claim 16, wherein said first biometric reading associated with said new user and said second biometric reading associated with said subscriber are received within a predefined time duration.

18. The computer-readable medium of claim 12, wherein said notifying comprises at least one of: calling said subscriber, emailing said subscriber, or instant messaging said subscriber.

19. The computer-readable medium of claim 13, wherein said modifying step comprises:
identifying said new user;
identifying a pre-defined set of services associated with said new user; and
providing only said pre-defined set of services to said new user.

20. A system for detecting a transfer of an endpoint device, comprising:
means for receiving an indication of a transfer of an endpoint device to a new user by a service provider; and
means for notifying a subscriber associated with said endpoint device that said indication of said transfer was received by said service provider.
